(19) United States
(12) Patent Application Publication
(10) Pub. No.: US 2023/0214868 A1
(43) Pub. Date: Jul. 6, 2023

(54) SYSTEM FOR A PLATFORM CONFIGURED FOR ONLINE SOCIAL INTERACTION

(71) Applicant: WOOO SOCIAL GAMES INC, MIAMI, FL (US)

(72) Inventor: Matilde Bartolotta Cingolani, Rome (IT)

(21) Appl. No.: 17/693,133

(22) Filed: Mar. 11, 2022

Related U.S. Application Data
(60) Provisional application No. 63/296,282, filed on Jan. 4, 2022.

(51) Int. Cl. G06Q 30/02; G06Q 50/00

(52) U.S. Cl. CPC G06Q 30/0209; G06Q 50/01

(57) ABSTRACT

One embodiment of the present invention is directed to a platform for social interaction, comprising a social interaction system configured to provide users with rewards upon the completion of a predetermined condition. Such a predetermined condition may range from using the user communication module of such social interaction system to communicate with other users thereof, or instead may comprise a user’s victory in a created competition through the submission of at least one user content package. As such, at least one embodiment of such a social interaction system comprises a competition module configured to generate and facilitate competitions, wherein such a competition module may automatically generate a competition according to a rules segment and a topic selection module. Rewards for completion of such a predetermined condition may range from intangible rewards, such as experience points, tangible rewards such as a tangible item, or even virtual currencies and/or non-fungible tokens.

### BACKGROUND OF THE INVENTION

### Claim of Priority

The present Non-Provisional patent application hereby makes a claim of priority to an earlier filed and currently pending U.S. Provisional Pat. Application having Serial No. 63/296,282 and a filing date of Jan. 4, 2022, which is hereby incorporated herewith in its entirety.

### FIELD OF THE INVENTION

The present invention is directed to a platform and system for online social interaction, wherein a reward may be conferred upon a user of such system upon the completion of predetermined condition, such as communicating with other users, or participating in and winning generated competitions based on user submitted content packages.

### DESCRIPTION OF THE RELATED ART

Conventional software platforms configured for online social interaction are constructed with a plurality of concepts in mind. Such platforms are typically constructed around two main principles: (1) the ability for a user to share his or her content, whether textual or graphical in nature, with his or her peers, friends, network, or complete strangers; and (2) the ability of other users to view such user-originated content, and to interact therewith, such as through likes, comments, and reposts. In so doing, online social interaction platforms enable users to communicate with each other about whatever is on their mind and, in so doing, facilitate social interaction.

However, as conventional social interaction platforms have been developed, and indeed become accepted by the public at large, one issue remains consistent therein. Specifically, none of such conventional social interaction platforms are configured to provide any semblance of value outside of the user’s interaction with other users. Indeed, the amount of likes or followers a person receives do not necessarily confer value upon a user. Even in the context of so-called influencers, conventional social interaction platforms are not configured to provide such influencers with direct value. Rather, the value obtained by influencers stems from outside sources, who seek to capitalize on the influencer’s group of followers. While perhaps not problematic for those illustrious individuals with a vast network of followers, the foregoing issue of value can be obstructive to those users comparatively lacking in pedigree. Yet, such users typically persist with conventional social interaction platforms despite this.

Considering the unique ability for individuals to market themselves through social interaction platforms, such as through uploading content intended to highlight an individual’s creativity, unique skillset, or otherwise convey the individual’s knowledge of a particular subject matter, the foregoing problem carries a degree of incongruity therewith. Indeed, it would be desirable for individuals from all walks to life to obtain value through online social interactions, whether tangible or intangible, as the same may facilitate creativity and ingenuity, and further enable individuals to better their own lives.

Accordingly, there is a need for an online social interaction platform configured to enable users to obtain value for their interactions provided thereon. Such an online social interaction platform should be configured to enable users to obtain both virtual and real-world value, such as through virtual points and tangible, real-world rewards through a variety of completed conditions, whether comprising interacting with friends, discovering new individuals to communicate with, or creating content found to be desirable amongst other users. Further, such an online social interaction platform should be configured to continually provide users with engagement through, for instance, competitions designed to capture user interest. Even further, such an online social interaction platform should additionally comprise certain elements configured to protect the privacy of its users, while also facilitating healthy practices in the real world, such as by restricting access to such an online social interaction platform.

### SUMMARY OF THE INVENTION

The present invention is directed to a solution to at least some, if not all the foregoing problems present in conventional online social interaction platforms. As such, at least one embodiment of the present invention may comprise a platform and/or system configured to use various computing devices and components to provide an online social interaction platform wherein one user may interact with at least one, and in most instances a plurality of other individuals, whether through the sharing of content or otherwise. At least one embodiment of the present invention may further be configured to provide such a user with a reward upon the completion of at least one predetermined condition, wherein such a reward may comprise some tangible or intangible value. In one further embodiment of the present invention, the completion of such at least one predetermined condition may comprise participation and/or victory in at least one created competition, which may be subject to at least one ruleset, whether pre-set or custom. Alternatively, such a reward may instead be conferred upon a user simply through the completion of other predetermined conditions, such as using such an online social interaction platform to simply interact with other users thereof, such as through direct messaging, phone calls, video calls, or otherwise. Even further, in at least one embodiment of the present invention, such a reward may be interconnected with a distributed ledger component, such that the reward constitutes some value of electronic currency or a non-fungible token. Thus, it may be understood various embodiments of the present invention may be configured so as to provide its users with some sort of value, whether tangible or intangible, through the mere use thereof.

For instance, one embodiment of the present invention may comprise a social interaction system through which a user may interact with another user. In at least one embodiment thereof, such a social interaction may be structured to operate across one or more computing devices, all of which may be interconnected through a network, such as the internet, or some other network, whether a local area network, a wide area network, a peer-to-peer network, a client/server network, or some other means akin thereto and configured for the functionality described herein, whether now known or hereafter developed. Such a computing device may comprise a smartphone, laptop, computer, tablet, or any other computing device having one or more processors configured to execute computer-readable code and/or instructions fed thereto. In at least one embodiment of the present invention, such a social interaction system may be provided for use on a website, or through a smartphone and/or tablet application, otherwise known as an app. Accordingly, at least one embodiment of the present invention may utilize at least one processor, server, and/or other computing device, or even a plurality thereof, in communication with a network to carry out the steps, components, module, algorithms, and other computing structures of the social interaction system.

At least one embodiment of such a social interaction system may comprise a variety of components configured to provide different functionalities for a user. For instance, such a social interaction system may comprise the following: (a) a user communication module configured to enable the user of one user device to communicate with a user of an alternative user device; (b) a posting module configured to enable the user of one user device to post at least one content package to the social interaction system; (c) a user interconnection module configured to enable the user of one user device to locate friends and other users; (d) a competition module configured to generate and facilitate at least one created competition; (e) a reward system configured to confer at least one reward upon a user upon the completion of a predetermined condition; (f) a restriction component configured to restrict a user’s access to the social interaction system; (g) a currency component configured to enable the user of such user device to exchange real currency for virtual currency; (h) a distributed ledger component configured to execute transaction data on a blockchain and/or distributed ledger system. As may be understood, each of the foregoing components, modules, and systems may be interconnected such that any action taken through one component thereof may be read into all other components. Each of the foregoing components, modules, and systems shall be discussed in greater detail hereafter.

As previously stated, the social interaction system of at least one embodiment of the present invention may comprise a user communication module, which may be configured to enable users of various user devices to communicate with one another. For instance, such a user communication module may comprise a chat component configured to enable various users to exchange text messages with each other, whether comprising text, images, videos, emphasis messages, such as a like, exclamation, question, or otherwise, or any other type of information typically conveyed through a text message, whether now known or hereafter developed. Such a user communication module may further comprise a call component. As may be understood, such a call component may be configured to enable users of social interaction system to communicate via a phone call or a video call, whether simply comprising two users or a plurality thereof. Even further, such a user communication module may be configured to enable users to interact with the content packages submitted by other users, whether through a comment chain, a like or some other voting mechanism, or otherwise.

In conjunction with the foregoing, the social interaction system of the present invention may also comprise a user interconnection module, which may be configured to enable users to interconnect with each other. For instance, such a user interconnection module may be configured for permissioned access to the contact list of a given user, such as the one disposed on a user’s smartphone, which may enable such a user to automatically identify those contacts already using the social interaction system described herein. Alternatively, such a user interconnection module may enable a given user to search for other users, such as through the username of other individuals. Even further, such a user interconnection module may additionally comprise a feed component or some other structure through which the content packages of other users may be displayed to a particular user. Such a feed component may be selectively tailored by a given user according to such user’s preferences. For instance, such feed component may allow a user to restrict content packages disposed on the same to only those featuring certain people, or directed to certain types of content, which may be indicated via a distinct identification sequence associated therewith. As may be understood, such a distinct identification sequence may comprise a hashtag or some other means of identifying, naming, or labelling a content package.

Further embodiments of the social interaction system of the present invention may additionally comprise a posting module. Such a posting module may be configured to enable a user to post a user content package, whether comprising an image, a video, a graphic interchange format file, or some other file type now known or hereafter developed to the social interaction system. Such a user content package may be posted by a user to his or her profile, or otherwise form at least a portion of a story, which may comprise a plurality of images, videos, or graphic interchange format files, or otherwise. Alternatively, such a posting module may instead by configured to enable a user to submit a user content package into a created competition, thereby entering the same, and through which alternative users may like and/or vote therefor.

As previously stated, at least one embodiment of the social interaction system of the present invention may further comprise a competition module, which may be configured to generate and facilitate competitions amongst the users of such social interaction system. For example, and without limitation, such a competition module may be configured to form at least one created competition, through which various users may submit a user content package, such as a photo, video, or otherwise, through the posting module. Such a created competition may comprise, for instance, a prompt for users to submit relevant content, and may be identified through, for instance, a unique identification sequence, such as a hashtag. For example, a created competition may prompt a user to submit an interesting picture of the user in nature, or instead may ask a user to submit a video for the best sports trick shot. Once submitted, such user content package may accrue voting data, whether comprising likes, votes, or otherwise. In conjunction therewith, it may be understood the voting data for such user content package may subsequently be compared to the voting data for the alternative user content packages submitted by other users for such created competition. In so doing, it may be understood a winner may be determined based on such voting data, or according to any other relevant data pertaining to the user content package.

In at least one embodiment of the present invention, such a competition module may comprise a rules segment, which may be configured to selectively apply a ruleset to the created competition. In so doing, it may be understood a created competition may thus take on a variety of different forms and functions dependent on the ruleset applied thereto. For instance, such a rules segment may comprise a pre-set rule package, which may itself comprise a variety of already premade rulesets configured to denote the type of competition at issue. Alternatively, such a rules segment may instead comprise a custom rule package, in which users are free to selectively apply their own rules to a given competition, which may then be subsequently proffered to such user’s friends and followers through, for instance, the user communication module, posting module, and/or user interconnection module.

For instance, the pre-set rule package of at least one embodiment of the present invention may comprise a variety of different rule packages configured to provide users with various types of competitions. As may be understood, the following rule packages are merely exemplary, and alternative types of rule packages are envisioned herein. Accordingly, exemplary embodiments of such pre-set rule packages may comprise: (a) a basic rule package; (b) a premium rule package; (c) an event-based rule package; and (d) a presentation rule package. Each of these pre-set rule packages will be briefly discussed hereafter.

In at least one embodiment of the present invention, such a basic rule package may comprise a created competition structured to enable all users of the social interaction system to participate. Thus, such a basic rule package may comprise a participation mechanism configured for open access, wherein all users of the social interaction system may participate, and thus submit at least one user content package therefor. Such a basic rule package may further comprise a timing mechanism configured for a predetermined submission window, whether comprising only a few hours, one day, several days, a week, or otherwise. Such a timing mechanism may be configured such that a countdown timer component is displayed in conjunction with the created competition, thereby providing users with knowledge as to the amount of time remaining for participation in such created competition. The voting mechanism for such a basic rule package may simply comprise the accrual of likes and/or votes, and the winner selection mechanism may be configured to simply select the user content package which accrues the most likes and/or votes within the aforementioned predetermined submission window. Upon selection of the winner, the reward system of the social interaction system may thus confer a reward upon the user, which shall be discussed in greater detail hereafter.

The premium rule package of at least one embodiment of the present invention may operate similar to the basic rule package. For instance, such a premium rule package may similarly incorporate the timing mechanism, voting mechanism, and winner selection mechanism utilized by the basic rule package, with the intent of selecting a winner of a created competition according to the number of likes and/or votes received for a given user content package within the allotted predetermined submission window.

Notably, however, the premium rule package may also differ from the basic rule package in several respects. For instance, in at least one embodiment of the present invention, the participation mechanism of the premium rule package may be configured for closed access, wherein only certain users are allowed to participate in the created competition. For example, such a premium rule package may be configured such that only users having accrued a predetermined user level, as will be discussed in greater detail hereafter, may participate in such created competition. Moreover, in at least one embodiment of the present invention, the participation mechanism of the premium rule package may further require an entrance fee, which may be conferred using the currency component of the social interaction system, which shall also be discussed in greater detail hereafter. Moreover, in at least one embodiment, the participation mechanism may be configured to limit the number of users allowed to participate in such a created competition. For instance, such a participation mechanism may limit the number of users allowed to participate to ten total users, thereby providing the users with a specified winning likelihood. As may be understood, the foregoing limitation on the number of users is merely exemplary, as other amounts of user participation, and thus alternative values of specified winning likelihood are contemplated herein.

Even further, the reward system of the social interaction system may further operate differently for certain embodiments of such a premium rule package. Specifically, the premium rule package may be configured to provide users with a tangible reward or intangible reward. As will be discussed in greater detail hereafter, such a tangible reward may comprise, for instance, a gift card comprising a set amount of fiat currency, or some tangible item, such as an item associated with the given topic of the created competition. For instance, if the created competition pertains to baking - e.g., who can create the best-looking sourdough bread - then the reward in a premium rule package may comprise some baking tool, such a stand mixer or some other tangible item. Likewise, if the topic of the created competition pertains to some sport activity - e.g., who can create the coolest golf trick shot - then the reward in a premium rule package may comprise some item related to golf, such as a new golf club.

As previously stated, an additional embodiment of the preset rule package may comprise an event rule package. Such an event rule package may operate similarly to the aforementioned basic rule package and/or premium rule package and may thus be configured for open access or closed access. However, such event rule package may differ in respect to the topic of the created competition and/or the predetermined submission window. For instance, such an event rule package may be configured such that users may only submit a user content package associated with a given event. In other words, such an event rule package may be configured for access only be users located at a certain event, whether a concert, sporting event, or otherwise. As such, the predetermined submission window may be configured to only allow for submissions of user content packages during the timeframe of such event. As may be understood, the reward system of the social interaction system may be configured for both tangible and intangible rewards dependent upon the type of event rule package utilized.

Further, at least one embodiment of the preset rule package of the present invention may further comprise a presentation rule package. Such a presentation rule package may differ from the other preset rule packages in certain respects, with the intention of providing users with the opportunity to obtain a tangible reward specifically directed to improving one’s professional status in the real world. For instance, the reward system associated with such a presentation rule package may be configured to confer a college scholarship or credits for some professional training and/or education programs. As such, the presentation rule package may be open access, such that all users of the social interaction system may present themselves via the user content package submitted for such a competition. Alternatively, such a presentation rule package may instead be configured as a means through which a single user may instead present a user content package without the context of a competition. As may be understood, such a user content package in the context of a presentation rule package may thus simply be disposed on a user’s profile, such that it is available for all users of the social interaction system to view. In so doing, it may be understood users of at least one embodiment of the social interaction system may thus shop themselves and seek to obtain tangible rewards based on the content he or she produces.

Further embodiments of the rules segment of the present invention may additionally comprise different components which may be used in the formation of a created competition. For instance, such a rules segment may additionally comprise a timing mechanism, which may be selectively adjusted to change the amount of time in which users may submit a user content package into the created competition. Likewise, such a rules segment may comprise a voting mechanism, which may alter the manner in which votes are tallied, accrued, or otherwise enabled for such user content package. And, finally, such a rules segment may additionally comprise a winner selection mechanism, which may outline the manner in which a winner is selected from the participating users.

Returning to the competition module, it may be understood a user may be configured to use the same to form a created competition, such as through selecting a pre-set rule package, or otherwise using a custom rule package to form a created competition, such as by selectively applying the timing mechanism, voting mechanism, and/or winner selection mechanism to such a created competition. However, it should also be understood such a competition module may instead by configured to automatically generate a created competition, which may be open to the public. Once again, such an automatically generated competition may utilize either a pre-set rule package or a custom rule package in creating the same.

Thus, at least one embodiment of the competition module may further be configured to automatically determine a topic for such automatically generated competition. Alternatively put, such a competition module may be configured to determine an appropriate topic for a competition - i.e., one intended to maximize participation therein. Specifically, such a competition module may comprise a topic selection module configured to select a topic for the automatically generated competition. Such a topic selection module may, in at least one embodiment of the present invention, be configured to access historical competition data associated with previously conducted competitions, whether automatically created by the competition module, selectively determined by a user of the social interaction system, or otherwise, to determine an appropriate topic for a given competition.

For instance, the historical competition data of at least one embodiment of the present invention may comprise the following data: (a) submission data, representing the number user content packages submitted for a given historical competition; (b) voting data, representing the number of votes received for any one user content package, as well as the number of aggregate votes received for all user content packages associated with a given historical competition; (c) date data, representing the date a historical competition commenced and ended, as well as the date of submissions of user content packages; (d) topic data, representing the topic associated with either the historical competition and/or user content packages, which may be denoted through, for instance, a unique identification sequence, such as a hashtag; (e) leaderboard data, representing the amount of users having a predetermined leaderboard ranking who participated in a historical competition; and (e) prize data, indicating the prize awarded to the winner of a historical competition. As may be understood, the foregoing types of historical competition data are merely exemplary, and alternative types of data are envisioned herein.

In accordance with the foregoing, such a topic selection module may comprise various components configured to analyze the foregoing pieces of historical competition data in a variety of ways. For instance, in at least one embodiment of the present invention, such a topic selection module may comprise a popularity component, which may determine the popularity of a given contest via, for instance, the voting data and the topic data, thereby collectively indicating the amount of likes and/or votes associated with a given topic. Likewise, a volume component may be configured to determine the amount of user submissions of user content packages associated with a given topic, such as through the submission data, leaderboard participation data, and the topic data. Even further, a freshness component may be utilized to identify new topics for competition, such as through leaderboard data, whereas a throwback component may be configured to identify past topics for competitions that may be worthwhile to revisit after a certain period of time, such as through the date data, submission data, topic data, and voting data. As may be understood, such a topic selection module may, in at least one embodiment of the present invention, use the information provided by each of the foregoing components to determine a predicted engagement score, through which such topic selection module may determine whether the considered topic is suitable for a competition to be created.

Even further, the topic selection module of at least one embodiment of the present invention may additionally comprise an accuracy component, which may be configured to validate the topic automatically selected for a given competition. Such an accuracy component may thus utilize the competition data, including the submission data, topic data, voting data, date data, leaderboard participation data, and prize data to determine whether a given competition yielded a level of expected engagement with the users of the social interaction system. As may be understood, such accuracy component may be configured to generate accuracy data according to the foregoing competition data, as well as other competition data not explicitly recited herein, to determine a score, ranking, or other piece of numerical data indicative of the engagement success of a given competition. Accordingly, such accuracy data may likewise be used in subsequent generations of created competitions, thereby providing such topic selection module with an expected engagement metric. Thus, as the topic selection module continues to generate competitions, the accuracy component continues to develop accuracy data, thereby enabling the topic selection module to continually create competitions having topics which receive continually higher scores in the expected engagement metric. In so doing, the topic selection module may thus continually improve, and thereby provide users with new topics for competitions which may boost user engagement, and thus enable users to continually seek rewards while being interested in the type of content such users are producing.

In conjunction with the foregoing, at least one embodiment of the social interaction system of the present invention may comprise a reward system. Such a reward system may be configured to confer a reward upon a given user upon the completion of a plurality of predetermined events, ranging from simply using the user communication module and/or user interconnection module to interact with friends and other users of the social interaction system, or otherwise winning a created competition. Accordingly, it may be understood the reward system may be configured provide a different reward dependent upon the predetermined condition met by the user. As previously stated, the reward(s) conferred by the reward system may comprise either tangible or intangible rewards, as will be discussed in greater detail hereafter.

More specifically, the reward system may comprise a reward determination component, an awarding component, and a reward aggregator component. Such a reward determination component may be configured to identify the predetermined condition met by a given user, and thus determine the appropriate award to be conferred upon the user. For instance, such a reward determination component may identify that a user communicated with another user of the social interaction system using the user communication module, such as through a text and/or phone call. Dependent upon the length of such phone call and/or the amount of text messages exchanged, or upon such other reward determination metric, the reward determination component may thus determine a reward to be conferred upon the user. In instances of use of the user communication module and/or the user interconnection module, the reward determination component may identify a set amount of experience points to be conferred upon a user – i.e., an intangible reward to be given to the user. Likewise, a user’s victory in a created competition applying a basic rule package may likewise confer experience points upon a user. In contrast, victory in a premium rule package, of instance, may instead confer either intangible or tangible rewards. Such intangible rewards may comprise, for instance, filters or other components of the social interaction system which are locked to users either lacking sufficient experience points, or otherwise requiring victory in a competition. As may be understood, such filters and other like components may then subsequently be utilized by the user when communicating with other users or otherwise creating user content packages for submission in a created competition. As may be understood, the reward determination component of at least one embodiment of the present invention may be configured to selectively enhance and/or diminish the intangible rewards, and more specifically the experience points conferred upon a user depending on the predetermined condition met. In other words, such a reward determination component may be configured to encourage users to participate in other aspects of the social interaction system by rewarding users for participating in new ways therein.

Conversely, as previously discussed, such a reward determination component may instead confer a tangible reward upon a user upon the completion of certain predetermined conditions, such as victory in a created competition formed under a premium rule package, an event rule package, or a presentation rule package. In at least some embodiments, such a tangible reward may be preidentified by the reward determination component – i.e., the reward determination component may select such a reward prior to initiating the created competition. As previously stated, such a tangible reward may comprise a monetary value, a scholarship, credits for professional and/or educational program, tangible items, or anything in between. As may be understood, in at least one embodiment of the present invention, such tangible rewards may be offered by a third-party offering to sponsor a given created competition.

Finally, it may also be understood such a reward system may instead by configured to reward users with some blend of a tangible and intangible reward. Specifically, such a reward system may instead confer upon a user some amount of a cryptocurrency, or perhaps a non-fungible token. Accordingly, it may be understood the reward determination component may thus be configured to identify an appropriate amount of cryptocurrency to be awarded to a user, or a non-fungible token having an appropriate value. As may be understood, the cryptocurrencies to be awarded by the reward system may comprise any cryptocurrency or stablecoin now known or hereafter developed, such as Bitcoin, Ethereum, or even a unique cryptocurrency specifically associated with the social interaction system described herein.

In conjunction therewith, such a reward system may further comprise an awarding component. In instances of an intangible reward, such an awarding component may simply post experience points to a user’s account, or otherwise automatically unlock additional features, such as filters, alternative means of communicating with other users, such as video parties, or otherwise. In the context of tangible rewards, such an awarding component may be configured to provide means through which a user may select how to receive such a tangible reward. For instance, a gift card having some real amount of fiat currency may be selected by a user to be sent to the email address associated with the user’s account. In contrast, tangible items may be selected to be mailed to a user according to an address supplied by the user. And finally, in the context of cryptocurrency and/or non-fungible token-based rewards, such an awarding component may be configured to record transactions on an appropriate blockchain or some other distributed ledger system, thereby effectuating a conference of such reward upon a user through, for instance, a virtual wallet.

Further, the reward system of at least one embodiment of the present invention may additionally comprise a reward aggregator component. Such a reward aggregator component may principally apply to the intangible rewards conferred upon a user – i.e., the experience points awarded to a user upon the completion of a predetermined condition. In other words, such a reward aggregator may continually aggregate all experience points awarded to a given user profile, thereby ensuring such user continually accrues experience points, and thus receives the fruits of his or her labor. Such a reward aggregator component may further be configured to display a leaderboard for the social interaction system. Such a leaderboard may thus identify and rank users according to the experience points accrued through use of the social interaction system. In at least one embodiment, such a leaderboard may have a variety of different filters available, such that a user may identify his or her placement on the leaderboard according to different metrics. For instance, such a leaderboard may be configured to filter the results according to the geographic location of users, or even according to the types of topics such user has participated in. For instance, such a leaderboard may be filtered according to the distinct identification sequence associated with a given created competition, such as through a hashtag, such that users may identify where they rank in a given topic.

Moreover, such a reward aggregator component may further be configured to identify a user’s level according to the experience points accrued by such user. Such a user level may be used, as previously stated, to confer eligibility upon a user intending to enter, for instance, a created competition utilizing a premium rule package. In at least one embodiment, such a user level may differ according to the geographic location of the user and/or the distinct identification sequence. In other words, a user may have a different level depending on his or her engagement in certain topics of created competition, or alternatively, location-based competitions. Thus, it may be understood a user may be allowed access to certain created competitions if that user has a sufficient level associated with the distinct identification sequence associated with such topic.

As previously stated, at least one embodiment of the social interaction system of the present invention may further comprise a restriction component. Such a restriction component may be configured to restrict a user’s access to such social interaction system, with the intent of encouraging users to take time away from participating in such social interaction system. Accordingly, the restriction component of at least one embodiment of the present invention may be configured to apply a restriction window and a predetermined participation timeframe. As but one example, after completion of a predetermined participation timeframe by a user, wherein such predetermined participation timeframe comprises engagement within the social interaction system of six hours within a twenty-four hour window, a restriction window of eighteen hours may be applied. Accordingly, the restriction component may thus prevent a user from logging onto the social interaction system throughout the duration of such restriction window. As may be understood, the foregoing example is merely exemplary, as alternative restriction windows and predetermined participation timeframes are envisioned herein.

Additional embodiments of the social interaction system of the present invention may comprise a currency component. Such a currency component may be configured to enable users to exchange real currency for virtual currency. More specifically, such a currency component may be configured to enable a user to purchase virtual currency, which may be used to purchase, for instance, certain unlockable content within such social interaction system, such as filters and other content-editing features, or alternatively participate in competitions wherein an entrance fee is required, such as a created competition formed under a premium rule package.

Further, at least one additional embodiment of the social interaction system of the present invention may comprise a distributed ledger component. Such a distributed ledger component may be configured to record transactions on a particular blockchain and/or distributed ledger. For instance, in the context of cryptocurrency and/or non-fungible token-based rewards, such a distributed ledger component may operate in concert with the reward system to confer such a reward upon the user. Thus, it may be understood the distributed ledger component may effectuate the necessary transactions on the given distributed ledger to effectuate such a transfer. Moreover, in at least one embodiment of the present invention, such as distributed ledger component may be configured to enable users to create, for instance, a non-fungible token.

These and other objects, features, and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 depicts a schematic representation of a social interaction system, in accordance with at least one embodiment of the present invention.

FIG. 2 depicts a schematic representation of a plurality of user devices interconnected with a server, through which the social interaction system of at least one embodiment of the present invention is provided.

FIGS. 3A and 3B depicts alternative graphical representations of a graphic user interface, in accordance with at least one embodiment of the present invention.

FIG. 4 depicts a schematic representation of a social interaction system, in accordance with at least one embodiment of the present invention.

FIG. 5 depicts a schematic representation of a competition module, in accordance with at least one embodiment of the present invention.

Like reference numerals refer to like parts throughout the several views of the drawings.

### DETAILED DESCRIPTION OF THE PREFERRED EMBODIMENT

The present invention is directed towards a computer-implemented system for an online social interaction platform configured, at least in part, to confer value upon a user of the same. More specifically, at least one embodiment of the present invention may comprise a social interaction system wherein users thereof may interact with one another, post user content packages, and even compete amongst each other for various rewards, whether tangible or intangible. Such rewards may be determined and conferred upon a user dependent upon the completion of a predetermined condition, whether comprising interacting with other users such as through texts, calls, or video calls, inviting friends to the social interaction system, and/or competing in and winning created competitions. Thus, various embodiments of the present invention comprise various components and structures configured to enable users to interact with each other, while simultaneously earning rewards directed to both the user’s experience within the social interaction system, and the user’s experience in the real world.

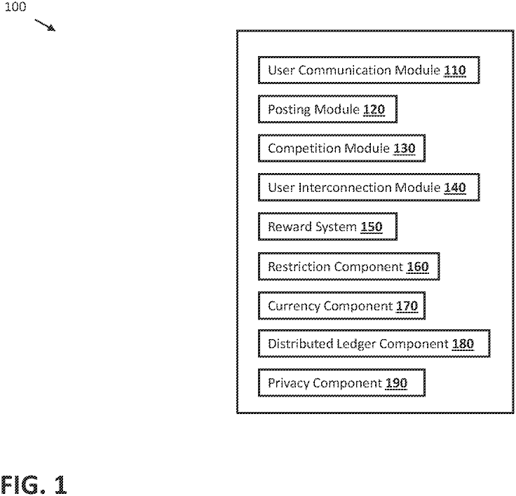

As may be seen with reference to FIG. 1, at least one embodiment of the social interaction system 100 of the present invention may comprise the following components: (a) a user communication module 110 configured to enable a user to communicate with other users of the social interaction system 100; (b) a posting module 120 configured to enable users to post at least one content package to the social interaction system 100; (c) a user interconnection module 130 configured to enable users to connect with other users of the social interaction system 100; (d) a competition module 140 configured to generate a created competition through which users may compete via the posting of at least one user content package; (e) a reward system 150 configured to confer at least one reward upon a user upon the completion of a predetermined condition; (f) a restriction component 160 configured to restrict a user’s access to the social interaction system 100; (g) a currency component 170 configured to enable users to exchange real currency for virtual currency; (h) a distributed ledger system 180 configured to execute transactional data on a distributed ledger or some other blockchain; and (i) a privacy component 190 configured to reduce or otherwise vitiate the storage of user data. Each of these components of the social interaction system 100 shall be discussed in greater detail hereafter.

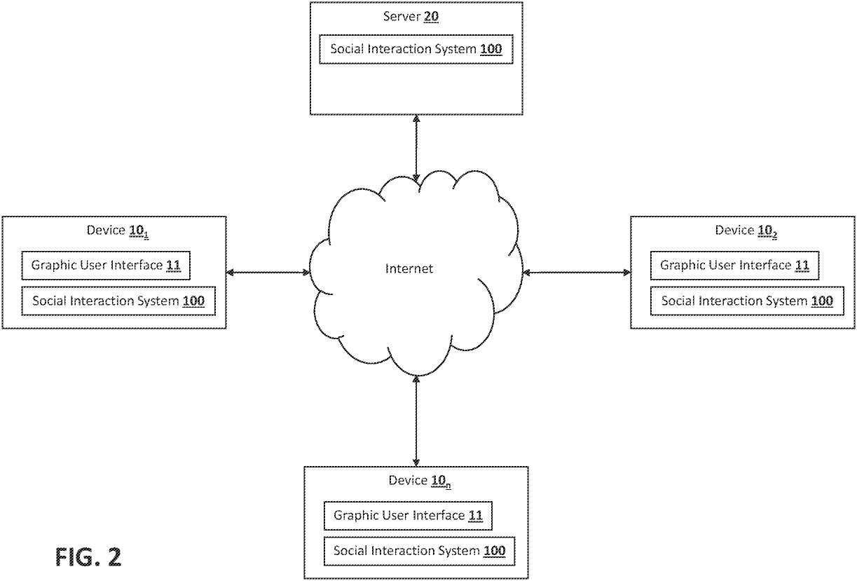

As may be seen with reference to FIG. 2, it may be seen at least one embodiment of the present invention may comprise a social interaction system 100 disposed on at least one, and in most instances a plurality of interconnected user devices 10₁ - 10ₙ. Such user device(s) 10 may comprise, for instance, a smartphone, a laptop, a tablet, a desktop computer, or some other computing device having one or more processors configured to execute computer-readable code and/or instructions. Thus, it may be understood that each such user device 10 may comprise a graphic user interface 11 configured to display information to a user. In conjunction therewith, such a social interaction system 100 may comprise a website, smartphone application, or some other platform configured to display information to a user through such graphic user interface 11. Accordingly, it may be understood the user device 10 may be configured in input-output relation with such social interaction system 100, such that a user of the user device 10 may issue and receive computer-readable instructions and/or code to the social interaction system 100, which may thus be displayed on the graphic user interface 11. Further, in at least one embodiment, all such user device may be interconnected with a server 20, such as processor or other computer device, through the internet, or some other network configured to interconnect all such user device 10 both with each other and the server 20. As may be understood, at least one embodiment of the social interaction platform 100 may be configured for permissioned-based access to other components of the user device 10, such as a user’s photos, camera, contact list, or otherwise.

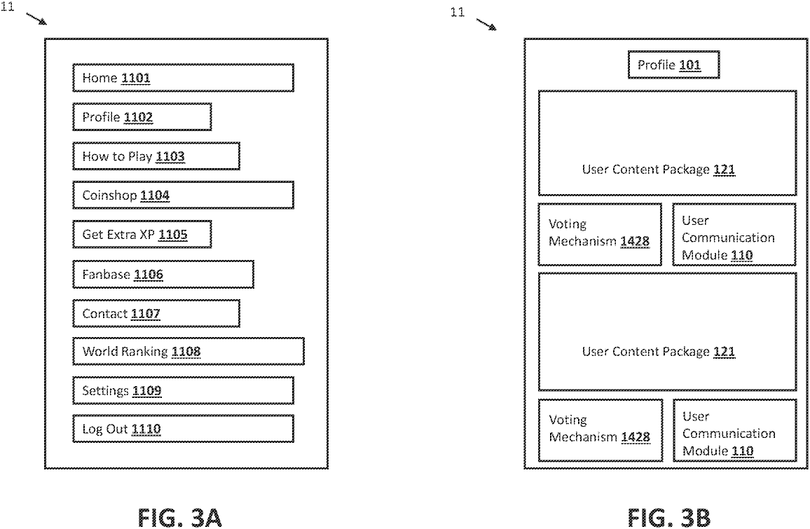

As may be understood, the graphic user interface 11 of various embodiments of the present invention may depict a variety of information for a user and may thus take on a variety of different structures. For instance, as depicted in FIG. 3A, such a graphic user interface 11 may depict a home screen through which a user may access the social interaction system 100, and subsequently determine how to use the same. For instance, such a graphic user interface 11 may comprise a variety of buttons, links, and/or webpages through which a user may navigate the social interaction platform 100. For instance, as depicted in FIG. 3A, a home screen of the graphic user interface 11 for a user device 10 comprising a smartphone, wherein such social interaction platform 100 comprises a mobile application, may comprise the following button each selectable by a user to direct the user to a new location of the social interaction platform 100: (a) a home button 1101, configured to return the user to the home page of the social interaction platform 100; (b) a profile button 1102, configured to take the user to his or her profile page; (c) a how to play button 1103, configured to take the user to a page instructing the user how to use the social interaction platform 100; (d) a coinshop button 1104, configured to take the user to the currency component 170, as will be discussed in greater detail hereafter; (e) a “Get Extra XP” button 1105, configured to take the user to locations of the social interaction platform 100 wherein a user may obtain additional rewards; (f) a fanbase button 1106, configured to take a user to a list of the other users following him or her; (g) a contact button 1107, configured to provide a user with various means to communicate with other users; (h) a world ranking 1108 button, configured to take the user to the leaderboard component 164, as will be discussed in greater detail hereafter; (i) a settings button 1109, configured to enable a user to alter the settings of the social interaction platform 100; and (j) a log out button 1110, configured to enable a user to exit the social interaction platform 100. As may be understood, the foregoing depiction of a home page for the social interaction platform 100 is merely exemplary, and thus meant to be non-limiting.

Another example of the graphic user interface 11 of the social interaction platform 100 of the present invention may be seen with reference to FIG. 3B. Depicted therein is a user’s profile 101, which may depict the user content package(s) 121 posted by the user through the posting module 120. Likewise, such a graphic user interface 11 may additionally depict other aspects of the social interaction platform 100, such as the voting mechanism 1428, through which other users may like and/or vote for the user content package(s) 121, as well as buttons through which users may communicate with other users, such as through the user communication module 110. As may be understood, a similar graphic user interface 11 may be used to depict, for instance, a user’s feed, such as through the feed component 123 of the user interconnection module 140, which may instead depict the user content package(s) 121 of alternative users. As before, the graphic user interface 11 depicted therein is merely exemplary, and thus non-limiting.

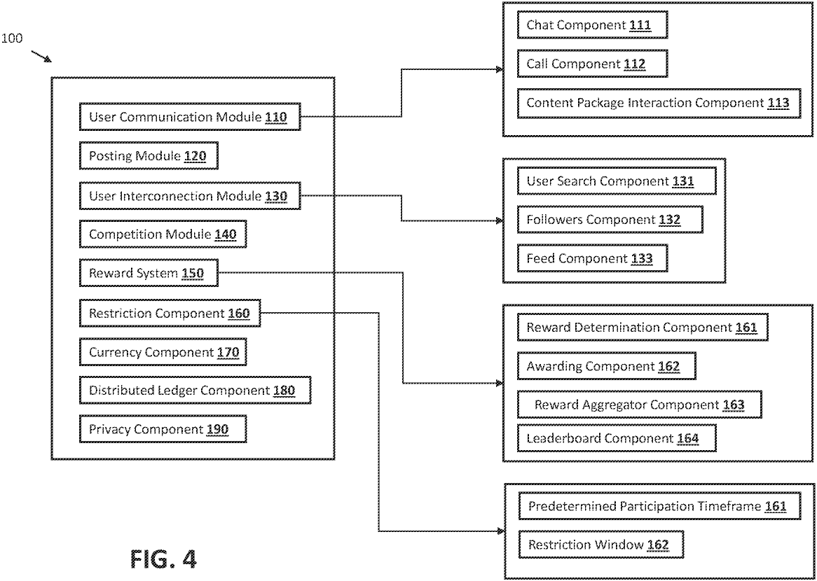

Depicted in FIG. 4 is but one embodiment of the social interaction system 100 of the present invention. As may be seen, one such embodiment thereof may comprise a user communication module 110, which may be configured to enable users of various user devices 10 to communicate with each other. For instance, such a user communication module 110 may comprise a chat component 111, which may comprise an instant messaging system through which a user may send text messages, images, videos, and other data to another user. As may be understood, such a chat component 111 may further comprise various emphasis features as well, whether comprising an exclamation, question, or any other component through which a user may add emphasis to a particular message disposed within the text chain of the chat component 111.

Further, the communication module 110 of at least one embodiment of the present invention may comprise a call component 112, through which a user may communicate with another user, or users, through for instance, a phone call or video call. In at least one embodiment of the present invention, certain features of the call component 112 may be initially inaccessible to a user and may be unlocked via the reward system 150 described hereafter.

Moreover, the communication module 110 of at least one embodiment of the present invention may further comprise a content package interaction component 113, through which a user may communicate with other users, such as public messages configured in connection with a distinct user content package 121. Accordingly, it may be understood the content package interaction component 113 is intrinsically tied to specific user content packages 121, thereby enabling a plurality of users to interact within the context of a single user content package 121.

With continued reference to FIG. 4, the social interaction system 100 of at least one embodiment of the present invention may comprise a posting module 120, through which a user may post a user content package 121. Such a user content package 121 may comprise an image, a video, a graphic interchange format file, or some other file type now known or hereafter developed. In one embodiment, such a user content package 121 may simply be a post to a user’s profile. Alternatively, such a user content package 121 may comprise a story, also posted to a user’s profile, which may comprise a plurality of images, videos, and the like, and may only be available for viewing by other users for a limited period of time. Further, such a user content package 121 may instead comprise a submission to a created competition, thereby constituting entrance therefor, and for which alternative users may like and/or vote therefor.

In conjunction with the foregoing, at least one embodiment of the social interaction system 100 of the present invention may comprise a user interconnection module 130. As depicted in FIG. 4, such a user interconnection module 130 may comprise a variety of components through which users of the social interaction system 100 may find friends, invite other users, or otherwise locate user content packages 121. For instance, such a user interconnection module 130 may comprise a user search component 121, which may enable a user to search for other users through, for instance, the username of another individual. Such a user interconnection module 130 may additionally comprise a followers component 132, through which a user may follow another user, and thereby gain access to his or user content packages 121 and/or the ability to like and/or vote therefor. Moreover, such a followers component 132 may enable a user to invite other users to become a follower of his or her profile, whether the user already uses the social interaction system 100 disclosed herein, or otherwise. For instance, such a followers component 132 may be configured for permissioned-access to the contact list of a user device 10, and may, in at least one embodiment, automatically identify those individuals in the contact list who are already users of the social interaction system 100. For those individuals who are not already users of the social interaction system 100, such a followers component 132 may be configured to enable the user of the relevant user device 10 to invite such individuals to join the social interaction system 100 disclosed herein.

Further, such a user interconnection module 130 may comprise a feed component 133. Such a feed component may be configured to display user content package(s) 121 of other users, such as those whom the user of the user device 10 follows. Alternatively, such a feed component 133 may instead be configured to display user content package(s) 121 of users whom the relevant user does not follow. Accordingly, it may be understood the feed component 133 may thus be selectively configured by the pertinent user to only display that content associated with his or her preferences. For instance, such a feed component 133 may be configured to display user content package(s) 121 associated with a given unique identifier sequence, such as a hashtag, whether posted by an individual whom the pertinent user follows, or otherwise.

With further reference to FIG. 4, it may be seen at least one embodiment of the social interaction system 100 of the present invention may comprise a competition module 140, which may be configured to generate and facilitate at least one created competition through which various users may compete via the submission of at least one user content package 121 thereto. Such a competition 140 may generally be configured to receive the submissions of such user content packages 121, tally the likes and/or votes directed to distinct user content packages 121, and determine a winner therefrom.

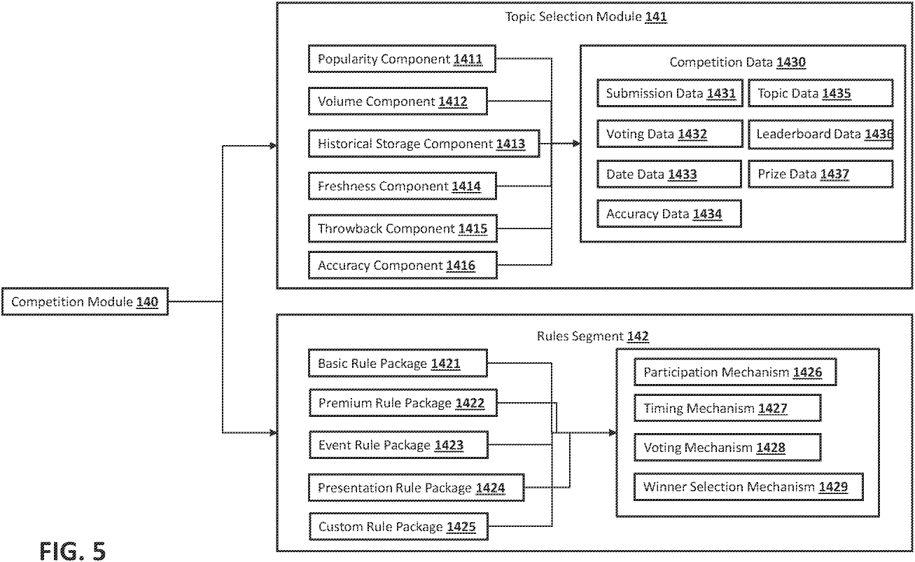

As previously discussed, and with reference to FIG. 5, it may be seen the competition module 140 of at least one embodiment of the present invention may comprise a rules segment 142 and a topic selection module 141, each of which shall be discussed in turn hereafter. Starting with the rules segment 142, it may be understood the competition module 140 may selectively apply a ruleset therefrom, which may form the foundations upon which the created competition is governed. Such a rules segment 142 may be configured to apply various rules through, for instance, a participation mechanism 1426, a timing mechanism 1427, a voting mechanism 1428, and a winner selection mechanism 1429, although alternative and additional such mechanisms and rules are envisioned herein. And, as previously discussed, such a rule segment 142 may selectively apply variations of the foregoing mechanisms in order to generate a created competition, whether based on a pre-set rule package or a customer rule package 1425.

For instance, the rules segment 142 of at least one embodiment of the present invention may comprise a basic rule package 1421, a premium rule package 1422, an event rule package 1423, and a presentation rule package 1424. Each of these rule packages are referred to herein as a pre-set rule package because the various rules inherent in each such rule package are already predetermined, and thus available for easy generation of a created competition, whether by the competition module 140, a user of the social interaction system 100, or otherwise. In contrast, the custom rule package 1425 may instead be configured for a user to selectively apply whatever rules he or she desires, thus enabling users to challenge one another according to a created competition tailored specifically for the user and his or her friends or followers. As may be understood, the pre-set rule packages outlined herein are merely exemplary, as alternative rulesets are envisioned herein.

The basic rule package 1421 of at least one embodiment of the present invention may be configured such that all users of the social interaction system 100 may participate. Thus, the participation mechanism 1426 of such a basic rule package 1421 may be configured for open access, thereby enabling any user of the social interaction system 100 to participate in a created competition formed under such basic rule package 1421. In at least one embodiment of the present invention, such basic rule package 1421 may comprise a timing mechanism 1427 configured to allow submissions of user content packages 121, and likes and/or votes therefor, within a predetermined submission window. Such a predetermined submission window may comprise one hour, a week, a month, a year, or any other applicable period of time. Such a basic rule package 1421 may further comprise a voting mechanism 1428, which, as previously discussed, may be configured to tally the likes and/or votes conferred upon each distinct user content package 121. Moreover, the basic rule package 1421 of such an embodiment may further comprise a winner selection mechanism 1429, which may determine a winner according to whichever user content package 121 receives the most votes and/or likes. However, it may be understood that alternative means of selecting a winner through such a winner selection mechanism 1429 may be applicable, such as through ranked voting, or according to a ratio between a user’s number of followers and the votes and/or likes received by the user content package 121 he or she submitted to the created competition.

In contrast, the premium rule package 1422 of at least one embodiment of the present invention may differ at least slightly from the aforementioned basic rule package 1421. Specifically, such a premium rule package 1422 may comprise a participation mechanism 1426 configured for closed access; thus, such a premium rule package 1422 may only be available for participation by certain users of the social interaction system 100. For instance, in at least one embodiment of the present invention, the participation mechanism 1426 for a premium rule package 1422 may restrict access to only those users having a high enough level and/or amount of accrued experience points and/or rewards. Likewise, such a participation mechanism 1426 may institute an entrance fee, which may be prerequisite to entrance into such created competition. Even further, such participation mechanism 1426 may restrict access to only a certain number of users, in order to increase the likelihood a participant in such created competition will win the same.

In conjunction with the foregoing, such a premium rule package 1422 may confer different rewards on the winner of the created competition formed thereunder. For instance, while a winner of a created competition formed under a basic rule package 1421 may only be rewarded with an intangible reward, such as experience points, the winner of a created competition formed under a premium rule package may win both intangible and tangible rewards. For instance, such a winner may receive an intangible reward, such as the unlocking of a feature of the social interaction system 100 previously locked, such as filters and other cosmetic features and/or content editing features, as well as a tangible reward, such as gift card or a tangible item. As may be understood, in at least one embodiment of the present invention, a third-party may offer a reward through a created competition formed under a premium rule package 1422.

One alternative type of pre-set rule package contemplated herein is an event rule package 1423. While such an event rule package 1423 may carry rules from either or both the basic rule package 1421 and the premium rule package 1422, such as the open or closed access of the participation mechanism, or the offering of either or both intangible and tangible rewards, such an event rule package 1423 may carry further restrictions. For instance, the timing mechanism 1427 may be configured such that it aligns with a real-world event, such as a sporting event or concert. Likewise, the participation mechanism 1426 of the event rule package 1423 may only be configured to allow submissions of user content packages 121 by users present at such event, which may be validated through some means, whether comprising the user’s geographic location, which may be configured for permission-access through the user’s smartphone, via a pre-submission of a user content package 121 directed to the user’s presence at such an event, such as through the submission of the user’s ticket, or via the user content package 121 itself.

Further, one other pre-set rule package envisioned herein is a presentation rule package 1424. Such a presentation rule package 1424 may be configured so as to provide users with rewards of great value, or otherwise directed specifically to the user’s experiences in the real world. More specifically, such a presentation rule package 1424 may be configured to enable users to present themselves through their user content packages 121, with the intent of obtaining a reward comprising, for instance, a college scholarship and/or credits for attending a professional training and/or education program. As such, the presentation rule package 1424 may, in at least one embodiment, be configured for open access through the participation mechanism 1426, may have an open-ended timing mechanism 1427, and may accrue votes and determine a winner through some alternative method. For instance, the winner selection mechanism 1429 of such a presentation rule package 1424 may instead select a winner according to alternative variables, such a geographic and/or demographic information associated with a user, and may ultimately be determined by an individual, such as a third-party offering such rewards. As previously stated, the specifics of such presentation rule package 1424, as well as the other pre-set rule packages described herein may be altered according to the desired social interaction system 100.

With further reference to FIG. 5, it may be seen the competition module 140 of at least one embodiment of the present invention may further comprise a topic selection module 141, which may be configured to automatically determine a topic for a competition to be created. As may be understood, certain embodiments of the present invention may be configured so as to generate a created competition without such a topic selection module 141, such as when a user him or herself deigns to create a competition.

Notwithstanding, such a topic selection module 141 may be configured to determine a topic for a competition to be created according to, for instance, competition data 1430 garnered from earlier competitions offered under the social interaction system 100. Such competition data 1430 may comprise, for instance: (a) submission data 1431, representing the number user content packages submitted for a given historical competition; (b) voting data 1432, representing the number of votes received for any one user content package, as well as the number of aggregate votes received for all user content packages associated with a given historical competition; (c) date data 1433, representing the date a historical competition commenced and ended, as well as the date of submissions of user content packages; (d) topic data 1435, representing the topic associated with either the historical competition and/or user content packages, which may be denoted through, for instance, a unique identification sequence, such as a hashtag; (e) leaderboard data 1436, representing the amount of users having a predetermined leadership ranking who participated in a historical competition; and (e) prize data 1437, indicating the prize awarded to the winner of a historical competition. As may be understood, the foregoing types of historical competition data 1430 are merely exemplary, and alternative types of such data are envisioned herein.

Thus, in accordance with the foregoing, the topic selection module 141 of at least one embodiment of the present invention may utilize such historical competition data 1430 through a variety of components configured to determine an ideal topic of a competition to be created. For instance, such a topic selection module 141 may comprise a popularity component 1411 configured to determine the likely popularity of a given topic. Such a popularity component 1411 may thus use at least some of such historical competition data 1430, such as the voting data 1432 and topic data 1435, in order to determine the amount of likes and/or votes associated with a given topic.

Likewise, such topic selection module 141 may comprise a volume component 1412, which may be configured to determine a likely amount of user submissions of user content packages 121 expected to be associated with a given topic, such as through the submission data 1431 and leaderboard data 1436. Similarly, a freshness component 1414 may strive to develop new topics for competition, such as through the leaderboard data 1436 and the topic data 1435. Conversely, a throwback component 1415 may instead opt to determine past topics which were previously successful, and which may be ripe for a comeback, such as through the date data 1433, topic data 1435, and voting data 1432. As may be understood, each such component of the topic selection module 141 may further utilize the prize data 1437 to assist in determining an appropriate prize for a competition, which may be based on the user-engagement a competition formed under a certain topic is predicted to generate. Thus, the topic selection module 141 may, in at least one embodiment, be configured to weigh each of the foregoing components to determine a predicted engagement score for a given topic and, according thereto, determine whether such a topic is suitable for the competition to be created.

In conjunction with the foregoing, such a topic selection module 141 may further comprise an accuracy component 1416. Such an accuracy component 1416 may be configured to validate the topic automatically selected for given competition according to the user engagement experienced by the created competition. Accordingly, such accuracy component may use all the historical competition data 1430, which additionally comprise accuracy data 1434. Such accuracy data 1434 may comprise a value used to determine a score, ranking, or some other piece of numerical data indicative of the engagement success of a given competition. In at least one embodiment, such accuracy data 1434 may further comprise a value indicative of the predicted engagement of a created competition versus the actual engagement received thereby. Accordingly, the topic selection module 141 may thus be configured to continually develop accuracy data 1434, and thus continually create competitions scoring higher accuracy data 1434, such that the created competitions generated by the topic selection module 141 may continually improve and achieve higher amounts of engagement.

Returning to FIG. 4, it may be seen at least one embodiment of the social interaction system 100 of the present invention may further comprise a reward system 150, which may be configured to determine, award, and aggregate rewards conferred upon a user upon the completion of a predetermined event. Specifically, such a reward system 150 may be configured to award a user with a given reward in a variety of circumstances, thereby rewarding an individual according to the time a user spends using the social interaction system 100. For instance, the reward system 150 may be configured to award intangible rewards, such as experience points or the unlocking of features within the social interaction system 100, upon a user for the completion of certain predetermined conditions. As an example, the reward system 150 may confer experience points when a user communicates with other users through the user communication module 110, or when such user connects with other users through the user interconnection module 130. Alternatively, experience points may instead be conferred upon participation and/or victory in certain created competitions, such as those formed under a basic rule package 1421. In contrast, the reward system 150 may instead confer tangible rewards, such as gift cards having monetary value or other tangible items upon the completion of other predetermined conditions, such as victory in a created competition formed under a premium rule package 1422.

Accordingly, and as may be seen with continued reference to FIG. 4, such a reward system 150 may comprise certain components configured to determine and award a given reward, whether intangible or tangible, upon a user. Likewise, such a reward system 150 may be configured to aggregate given rewards, such as the intangible experience points conferred upon a user, and display such information through a leaderboard component 164, which may display users and the experience points such users have accrued throughout their use of the social interaction system 100.

In conjunction with the foregoing, at least one embodiment of such a reward system 150 may comprise a reward determination component 151. As may be understood, such a reward determination component 151 may be configured to identify the predetermined condition met by a user, and subsequently determine the appropriate reward to confer thereto. For instance, the reward determination component 151 may determine an appropriate amount of experience points to confer upon a user dependent upon the length of time the user the utilizes the call component 112 to communicate with other users of the social interaction system 100. Likewise, the reward determination component 151 may determine an appropriate amount of experience points to confer upon a user dependent upon the number of messages communicated with another user through the chat component 111. As may be understood, the reward determination component 161 may be configured to apply a set amount of experience points in accordance with the foregoing completion of a predetermined condition or may instead selectively enhance or diminish reward to be conferred upon a user in order to encourage a user to participate in other aspects of the social interaction system 100.

Even further, such a reward system 150 may further be configured to instead confer rewards upon the user in the form of cryptocurrency and/or non-fungible tokens, which may be considered a blend of a tangible and/or intangible reward, which thus should not be construed as merely binary. Accordingly, the reward determination component 151 of at least one embodiment of the present invention may thus be configured to identify an appropriate amount of cryptocurrency to be awarded to a user, such as through the present value of same, or otherwise identify a non-fungible token having similarly having an appropriate value. As may be understood, the type of cryptocurrency to be awarded to a user may comprise any cryptocurrency, stablecoin, or other form of digital currency, such as Bitcoin and Ethereum, whether now known or hereafter developed. For instance, in at least one embodiment of the present invention, the social interaction system 100 may be configured to confer a digital currency specifically associated therewith.

In conjunction with the foregoing, the reward system 150 of at least one embodiment of the present invention may further comprise an awarding component 162, which may be configured to effectuate conferral of the reward on a user. In instances of an intangible reward, such as experience points or the unlocking of a feature within the social interaction system 100, such an awarding component may simply update the user’s account to reflect such changes. In the context of tangible rewards, such an awarding component 162 may instead be configured to enable users to selectively determine how he or she wishes to receive the same. For instance, a digital gift card may be transmitted to the user through his or email, whereas a tangible item may be shipped to a user according to a submitted shipping address. And, finally, in the context of cryptocurrency and/or non-fungible tokens, such an awarding component 162 may be configured for connection with distributed ledger component 180, which may enable the social interaction system 100 to record the relevant transactional data on an appropriate blockchain and/or distributed ledger system, and thus may enable a user to receive, for instance, cryptocurrency through a designated virtual wallet.

The reward system 150 of at least one embodiment of the present invention may further comprise a reward aggregator component 163, which may, at least in the context of experience points, be configured to continually track the rewards conferred upon a user. In connection therewith, such reward aggregator component 163 may display data pertaining thereto through a leaderboard component 164. Such a leaderboard component 164 may thus identify and rank users according to the amount of experience points accrued through the user’s use of the social interaction system 100. As may be understood, such leaderboard component may be customizable by a user via filtering or some other similarly situated means, thereby enabling a user to determine his or her position on the leaderboard dependent on various factors. Such filterable factors may comprise, for instance, the geographic location of users, the types of topics such user commonly participates in, and the amount of experience points conferred upon a user relative to the number of followers he or she has.

Additional embodiments of the social interaction system 100 of the present invention may comprise a restriction component 160. Such a restriction component 160 may be configured to restrict a user’s access to such social interaction system 100, and thereby promote and encourage users to participate in real-world social interactions as well. For instance, such a restriction component 160 may be configured to apply a restriction window 162 upon a user’s profile once a predetermined participation timeframe 161 has been met. For example, the restriction component 160 may be configured to apply an eighteen hour restriction window 162 if a user meets the predetermined participation timeframe 161 of six hours within a twenty-four hour time period. However, it may be understood the foregoing example is merely exemplary, as alternative restriction windows 162 and predetermined participation timeframes 161 are envisioned herein.

Yet additional embodiments of the social interaction system 100 of the present invention may comprise a currency component 170. Such a currency component 170 may be configured to enable a user to purchase virtual currency – i.e., currency only having value within the social interaction system 100 – for real currency – i.e., fiat currency or some other currency having real value. In so doing, such a social interaction system 100 may be configured to enable users to purchase features of the same, such as filters, content editing features, or cosmetic features, or otherwise obtain virtual currency for entrance into a created competition, such as one formed under a premium rule package 1422.

As previously discussed, such a social interaction system 100 may further comprise a distributed ledger component 180. Such a distributed ledger component 180 may be configured to record transactions on a particular blockchain and/or distributed ledger, whether directed to cryptocurrencies, stablecoins, non-fungible tokens, or otherwise. Moreover, in at least one embodiment, such a distributed ledger component 180 may instead be configured to enable users to create, for instance, non-fungible tokens according to a given user content package 121.

In yet additional embodiments of the present invention, such a social interaction system 100 may additionally comprise a privacy component 190. Such a privacy component 190 may be configured so as to restrict the tracking and analysis of user data, whether comprising user communications through the user communication module 110, user content packages 121 submitted to the social interaction system 100 for any reason, and any other pertinent user data. For example, in instances wherein geographic data for a user is received by the social interaction system 100, such privacy component 190 may be configured to destroy all data pertaining thereto once the distinct use thereof is completed. Likewise, in the context of the historical competition data 1430, such a privacy component 190 may be configured to randomize and anonymize the data stored by such competition module 140.

In view of the foregoing, it may be seen various embodiments of the social interaction system 100 of the present invention are configured so as to encourage user participation and engagement within the same by rewarding users for such participation and engagement. For instance, by conferring experience points upon users for communicating with other users through the user communication module 110, the social interaction system 100 of the present invention may encourage users to interact with each other. And by providing users with the possibility of obtaining tangible rewards, whether comprising some amount of real currency, a tangible item, a scholarship, or an amount of digital currency, user engagement and participation in created competitions and the like may be further facilitated. In conjunction therewith, the various rules segments upon which a competition may be created, and the automatic creation of competitions according to the topic selection module may further facilitate user engagement.

Since many modifications, variations, and changes in detail may be made to the described preferred embodiment of the present invention, it is intended that all matters in the foregoing description and shown in the accompanying drawings be interpreted as illustrative and not in a limiting sense. Thus, the scope of the invention should be determined by the appended claims and their legal equivalents.

1. A platform for online social interaction comprising:
a central processor configured in connection with a memory, said central processor configured for connection with a user processor of a plurality of user devices;
said central processor comprising a social interaction system configured for the online social interaction between the users of said plurality of user devices, said social interaction system comprising:
a user communication module configured to enable the users of said plurality of user devices to communicate with each other;
a posting module configured to enable the users of said plurality of user devices to post at least one user content package;
a competition module configured to generate at least one created competition;
said competition module comprising a topic selection module configured to automatically select a topic for said at least one created competition by determining a predicted engagement score for said topic according to historical competition data, said historical competition data comprising submission data, voting data, date data, topic data, leaderboard data, and prize data associated with at least one earlier competition;
said predicted engagement score comprising a weighted value of:
a popularity component configured to determine a likely popularity of said topic according to at least said voting data and said topic data;
a volume component configured to determine a likely engagement of said topic according to at least said submission data and said leaderboard data;
a reward system configured to reward the users of said plurality of user devices when one of such users completes at least one predetermined condition; and
said topic selection module further comprising an accuracy component configured to generate accuracy data relative to said predicted engagement score, said accuracy data stored as part of said historical competition data for use by said topic selection module in at least one future created competition.

2. (canceled)

3. (canceled)

4. (canceled)

5. The platform of claim 1, wherein said competition module comprises a rules segment configured to apply a ruleset to said at least one created competition.

6. The platform of claim 5, wherein said rules segment comprises a basic rule package, a premium rule package, an event rule package, and a presentation rule package.

7. The platform of claim 1, wherein said at least one predetermined condition comprises communication between the users of said plurality of user devices via said user communication module.

8. The platform of claim 1, wherein said at least one predetermined condition comprises the victory of one of the users of said plurality of user devices in said at least one created competition.

9. The platform of claim 1, wherein said reward system comprises a reward determination component configured to determine a reward dependent on the completion of said at least one predetermined condition.

10. The platform of claim 9, wherein said reward comprises an intangible reward.

11. The platform of claim 9, wherein said reward comprises a tangible reward.

12. The platform of claim 9, wherein said reward comprises an amount of digital currency.

13. The platform of claim 1, wherein said social interaction system further comprises a restriction component configured to apply a restriction window to one of the users of said plurality of user devices after such user meets a predetermined participation timeframe.

14. A social interaction system comprising:
a user communication module configured to enable a user of said social interaction system to communicate with at least one alternative user thereof;
a posting module configured to enable a user to submit at least one user content package to said social interaction system;
a competition module configured to generate at least one created competition, said at least one created competition configured for receipt of said at least one user content package;
said competition module comprising a participation mechanism configured to determine if said user may enter said at least one created competition;
said competition module further comprising a voting mechanism configured to aggregate votes afforded to said at least one user content package;
said competition module further comprising a winner selection mechanism configured to identify a winner of said at least one created competition;
said competition module configured in connection with a reward system, said reward system comprising a reward determination component configured to determine a reward to be conferred upon said winner of said at least one created competition;
said competition module further comprising a topic selection module configured to automatically select a topic for said at least one created competition according to a predicted engagement score determined from historical competition data associated with at least one earlier competition;
said historical competition data comprising submission data, voting data, date data, topic data, leaderboard data, prize data, and accuracy data;
said predicted engagement score comprising a weighted value of:
a popularity component configured to determine a likely popularity of said topic according to at least said voting data and said topic data;
a volume component configured to determine a likely engagement of said topic according to at least said submission data and said leaderboard data;
a freshness component configured to determine the newness of said topic according to at least said leaderboard data and said topic data;
a throwback component configured to determine the ripeness of said topic according to at least said date data, said topic data, and said voting data;
an accuracy component configured to determine accuracy data relative to an earlier predicted engagement score of said at least one earlier competition; and
a restriction component configured to apply a restriction window to said at least one user once said at least one user meets a predetermined participation timeframe.

15. The social interaction system of claim 14, wherein said reward system is further configured to confer an intangible reward upon said user upon the occurrence of a predetermined condition, said predetermined condition comprising the user of said user communication module by said user to communicate with said at least one alternative user.

16. (canceled)

17. (canceled)

18. The social interaction system of claim 14, wherein said reward comprises one selected from the group consisting of: an intangible reward, a tangible reward, and an amount of virtual currency.

19. The social interaction system of claim 14, wherein said reward system further comprises a leaderboard component configured to rank all users according to an aggregate amount of rewards received.

20. The social interaction system of claim 14, further comprising a distributed ledger component configured to record transactional data on at least one distributed ledger.
